(19) United States
(12) Patent Application Publication
(10) Pub. No.: US 2021/0190643 A1
(43) Pub. Date: Jun. 24, 2021

(54) BIOLOGICAL SAMPLE PROCESSING DEVICE

(71) Applicant: USTAR Biotechnologies (Hangzhou) Ltd., Hangzhou (CN)

(72) Inventors: Qimin YOU, Hangzhou (CN); Zhen Wang, Hangzhou (CN); Yanqiong Zhou, Hangzhou (CN); Fan Yang, Hangzhou (CN); Xin Zhao, Hangzhou (CN); Gang Sun, Hangzhou (CN); Xiangyu Yang, Hangzhou (CN); Yanlin Zhao, Hangzhou (CN); Bing Zhao, Hangzhou (CN); Xichao Ou, Hangzhou (CN); Guohua Ping, Hangzhou (CN); Beibei Wu, Hangzhou (CN)

(73) Assignee: USTAR Biotechnologies (Hangzhou) Ltd., Hangzhou (CN)

(21) Appl. No.: 17/249,587

(22) Filed: Mar. 5, 2021

Related U.S. Application Data
(63) Continuation of application No. PCT/CN2018/106460, filed on Sep. 19, 2018.

(30) Foreign Application Priority Data
Sep. 6, 2018 (CN) 201811039537.3

(51) Int. Cl. G01N 1/14; G01N 1/18; G01N 1/40

(52) U.S. Cl. CPC G01N 1/14; G01N 1/18; G01N 2001/4088; G01N 2001/1427; G01N 1/4077

(57) ABSTRACT

A biological sample processing device includes a containing bottle. A receiving opening is provided and a liquid outlet is provided. The device further includes an upper cover assembly and a lower cover. The upper cover assembly is connected to the upper end of the containing bottle. The lower cover is connected to the lower end of the containing bottle. The upper cover assembly includes an upper cover, a lower seal, a piston and a puncturing element. The upper cover is provided with a through hole, and the lower seal is disposed at a lower end of the through hole. The piston is closely matched with an inner wall of the through hole and can slide along the inner wall to drive the puncturing element to pierce the lower seal. The disclosure provides advantages that the biological sample can be processed by the provided device without opening the upper cover.

### TECHNICAL FIELD

The disclosure relates to a biological sample processing device.

### BACKGROUND ART

Acquisition and pretreatment of a biological sample are important links in a clinical examination, which directly affect an accuracy of a subsequent measurement result. Presently, the acquisition of the biological sample is made by collecting the sample (blood, urine, sputum, feces, or the like) into a corresponding container. The examiner opens the container and takes out the sample, or adds a treatment solution to the container to complete the pretreatment of the sample. A main defect existed in this process is that the examiner is directly exposed to aerosol with an infection risk when opening the container, which increases a risk of nosocomial infection. Therefore, there is a need for a safer sampling container that can protect the examiner from aerosol exposure.

### SUMMARY

To solve the shortcomings in the prior art, the present disclosure provides a biological sample processing device for solving the above problems.

In order to achieve the above object, the disclosure employs the following technical scheme.

A biological sample processing device includes a containing bottle for containing a biological sample to be processed. A receiving opening is provided at an upper end of the containing bottle and a liquid outlet being provided at a lower end of the containing bottle. The biological sample processing device further includes an upper cover assembly and a lower cover, the upper cover assembly is connected to the upper end, where the receiving opening is provided, of the containing bottle, the lower cover is connected to the lower end, where the liquid outlet is provided, of the containing bottle; wherein the upper cover assembly includes an upper cover, a lower seal, a piston and a puncturing element, the upper cover is provided with a through hole, and the lower seal is disposed at a lower side of the through hole provided in the upper cover so that the upper cover forms a cavity for containing a solution reacted with the biological sample, the puncturing element is connected to the piston, the piston is closely matched with an inner wall of the through hole provided in the upper cover and sliding along the inner wall to drive the puncturing element to pierce the lower seal, and the upper cover is at least partially positioned in a cavity provided in the containing bottle.

Further, the biological sample processing device further includes a filter, and the filter is placed in the cavity provided in the containing bottle to divide the cavity provided in the bottle into a first cavity and a second cavity.

Further, the containing bottle includes an upper connecting part, an elastically deformable bottle body and a lower connecting part, the bottle body is connected with the upper connecting part and the lower connecting part, the upper connecting part is provided with the receiving opening, and the lower connecting part is provided with the liquid outlet.

Further, an external thread is provided at an outer side of the upper connecting part, an upper end of the upper cover is integrally provided with a sleeve portion with an internal thread defined on an inner wall of the sleeve portion, and the inner wall of the sleeve portion is provided with the internal thread matched with the external thread provided at the outer side of the upper connecting part.

Further, a gap is provided between the upper cover and the bottle body.

Further, the lower connecting part is funnel-shaped, the liquid outlet is located at a tip of the lower connecting part, and the lower cover is provided with a funnel-shaped inner cavity matched with the lower connecting part.

Further, the lower connecting part includes a first funnel part, a cylindrical threaded connecting part with an external thread provided at an outer side of the threaded connecting part, and a second funnel part. The first funnel part is connected to a lower end of the bottle body, and an end of the threaded connecting part is connected to the first funnel part and the other end of the threaded connecting part is connected to the second funnel part; the liquid outlet is located at a tip of the second funnel part; and an inner wall of the funnel-shaped inner cavity, matched with the lower connecting part, of the lower cover is provided with an internal thread matched with the external thread provided at the outer side of the threaded connecting part.

Further, an end of the threaded connecting part proximate to the first funnel part extends along a radial direction to form a supporting part; the biological sample processing device further includes a filter, the filter is positioned in the lower connecting part and abutting against the supporting part.

Further, a lower end of the lower cover is located in a same plane, and the plane is perpendicular to a central axis of the containing bottle.

Further, the upper cover assembly further includes an upper sealing member, and the upper sealing member is disposed at an upper side of the through hole provided in the upper cover and the upper sealing member is cooperating with the lower sealing member to close the cavity enclosed by the upper cover for containing the solution reacted with the biological sample.

The disclosure provides an advantage that the biological sample can be processed by the provided biological sample processing device without opening the upper cover.

The disclosure provides an advantage that the biological sample processing device can be configured to centrifuge and accumulate biological sample precipitates, and to observe, culture or detect pathogenic microorganisms.

### BRIEF DESCRIPTION OF THE DRAWINGS

FIG. 1 is an exploded view of a biological sample processing device according to the present disclosure;

FIG. 2 is a sectional view of the biological sample processing device in FIG. 1; and

FIG. 3 is a sectional view of another working state of the biological sample processing device in FIG. 1.

biological sample processing device 100, containing bottle 10, receiving opening 11, liquid outlet 12, upper connecting part 13, bottle body 14, lower connecting part 15, first funnel part 151, threaded connecting part 152, second funnel part 153, supporting part 154, upper cover assembly 20, upper cover 21, sleeve portion 211, lower seal 22 and piston 23, puncturing member 24, upper seal 25, lower cover 30, and filter 40.

### DETAILED DESCRIPTION

The disclosure will be described in the following in detail with reference to the drawings and specific embodiments.

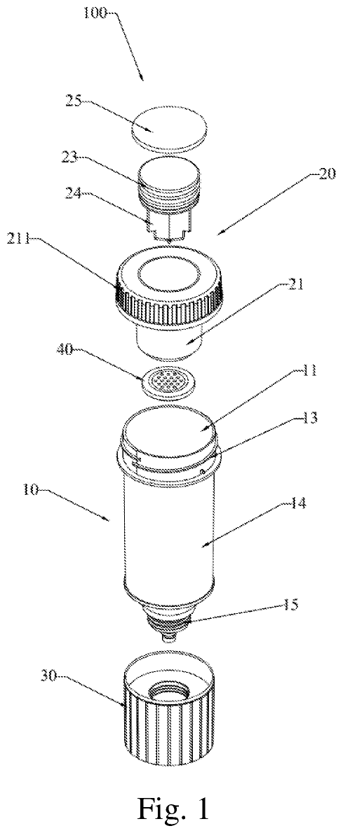

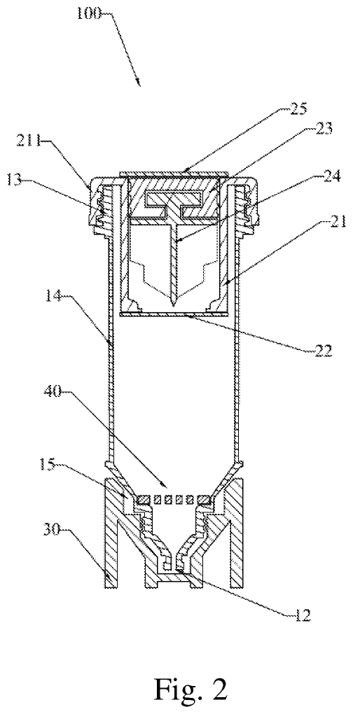

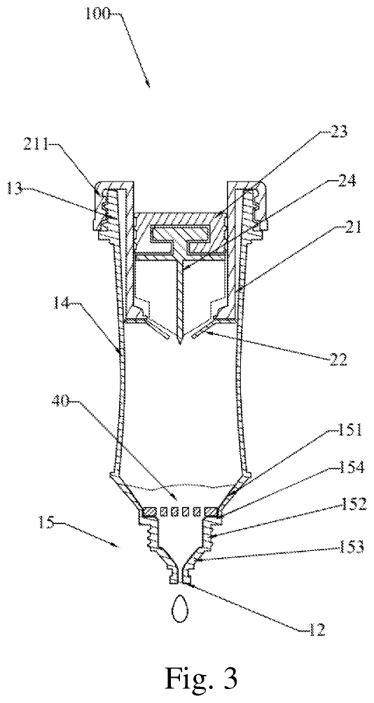

As shown in FIGS. 1 to 3, a biological sample processing device 100 for processing a biological sample is provided. The biological sample can be blood, urine, sputum, feces, or the like. The biological sample processing device 100 includes a containing bottle 10, an upper cover assembly 20 and a lower cover 30. The containing bottle 10 is used for containing the biological sample to be processed, and a receiving opening 11 is provided at an upper end of the containing bottle 10 and a liquid outlet 12 is provided at a lower end of the containing bottle. The liquid outlet 12 is preferably circular with a pore size ranging from 1 to 2 mm, preferably 1.5 mm. The upper cover assembly 20 is connected to the upper end, where the receiving opening 11 is provided, of the containing bottle 10 to close the receiving opening 11, and the lower cover 30 is connected to the lower end, where the liquid outlet 12 is provided, of the containing bottle 10 to close the liquid outlet 12.

Specifically, the upper cover assembly 20 includes an upper cover 21, a lower seal 22, a piston 23 and a puncturing element 24. The upper cover 21 is provided with a through hole, and the lower seal 22 is disposed at a lower side of the through hole provided in the upper cover 21 so that the upper cover 21 forms a cavity for containing a solution reacted with a biological sample. The lower seal 22 is a thin film or made of other easily punctured materials, preferably a polypropylene aluminum foil composite film, with a diameter ranging from 25 to 30 mm, preferably 28 mm, and a thickness ranging from 0.04-0.06 mm, preferably 0.05 mm. The puncturing element 24 is connected to the piston 23. The piston 23 is closely matched with an inner wall of the through hole provided in the upper cover 21 to close the through hole, and the piston 23 can slide along the inner wall to drive the puncturing element 24 to move. The piston 23 can be made of rubber, and the surface of the piston 23 contacting with the inner wall of the through hole provided in the upper cover 21 has a threaded structure. When the puncturing element 24 moves toward the lower end of the upper cover 21, it can pierce the lower seal 22. At this time, the solution stored in the upper cover 21 and reacted with the biological sample flows into the containing bottle 10 to react with the biological sample in the containing bottle 10, and the upper cover 21 is at least partially located in the cavity provided in the containing bottle 10. The puncturing element 24 is preferably a cross-shaped puncture structure, and is preferably of polyvinyl chloride plastic, with a puncture angle ranging from 30° to 60°, preferably 45°.

As a preferred embodiment, the biological sample processing device 100 further includes a filter 40. The filter 40 is placed in the cavity provided in the bottle 10 to divide the cavity provided in the bottle 10 into a first cavity and a second cavity.

Specifically, the filter 40 can be used for separating large-particle precipitates, and the filter 40 is preferably round, with a pore diameter ranging from 2 to 5 mm, preferably 3 mm.

As a preferred embodiment, the containing bottle 10 includes an upper connecting part 13, a bottle body 14 and a lower connecting part 15. The bottle body 14 is connected with the upper connecting part 13 and the lower connecting part 15. The upper connecting part 13 is provided with a receiving opening 11. The lower connecting part 15 is provided with a liquid outlet 12.

Specifically, the containing bottle 10 is preferably of polypropylene resin. The bottle body 14 can be elastically deformable, and the liquid in the containing bottle 10 can be squeezed out from the liquid outlet 12 by squeezing the bottle body 14. To ensure that the bottle body 14 has a proper elastic force, a thickness of the bottle body 14 ranges from 0.05 to 0.10 mm, preferably 0.07 mm.

As a preferred embodiment, an external thread is provided on an outer side of the upper connecting part 13. The upper end of the upper cover 21 is integrally provided with a sleeve portion 211 with an internal thread defined on an inner wall of the sleeve portion. The inner wall of the sleeve portion 211 is provided with the internal thread matched with the external thread provided on the outer side of the upper connecting part 13. When installing the upper cover 21, the sleeve portion 211 is sleeved on the upper connecting part 13, and then the upper cover 21 is rotated to install the upper cover 21 to the containing bottle 10.

As a preferred embodiment, a gap is provided between the upper cover 21 and the bottle body 14. A ratio of the gap provided between the upper cover 21 and the bottle body 14 to an inner diameter of the bottle body 14 ranges from 0.05 mm to 0.2 mm, preferably 0.07 mm.

Specifically, when the bottle body 14 is squeezed to release liquid in the containing bottle 10, the bottle body 14 is recessed inward. To ensure that the bottle body 14 has enough space to recess inward, a large enough gap needs to be provided between the upper cover 21 and the bottle body 14. Meanwhile, the gap between the upper cover 21 and the bottle body 14 affects a volume of the cavity in the upper cover 21 for containing the solution reacted with the biological sample, which should be not too small. The ratio of the gap provided between the upper cover 21 and the bottle body 14 to the inner diameter of the bottle body 14 ranges from 0.05 to 0.2, so that the volume of the inner cavity of the upper cover 21 is large enough while the bottle body 14 has enough space to recess inward.

As a preferred embodiment, the lower connecting portion 15 is funnel-shaped. The liquid outlet 12 is located at a tip of the lower connecting part 15. The lower cover 30 is provided with a funnel-shaped inner cavity matched with the lower connecting part 15.

As a preferred embodiment, the lower connecting part 15 includes a first funnel part 151, a cylindrical threaded connecting part 152 with an external thread provided on an outer side thereof and a second funnel part 153. The first funnel part 151 is connected to the lower end of the bottle body 14. An end of the threaded connecting part 152 is connected to the first funnel part 151 and the other end thereof is connected to the second funnel part 153. The liquid outlet 12 is located at a tip of the second funnel part 153. An inner wall of the funnel-shaped inner cavity, matched with the lower connecting part 15, of the lower cover 30 is provided with an internal thread matched with the external thread provided on the outer side of the threaded connecting part 152.

Specifically, a slope of the first funnel part 151 ranges from 30° to 60°, preferably 45°, and a slope of the second funnel part 153 ranges from 30° to 60°, preferably 45°, so that the sample can be completely reserved at a bottom of the containing bottle 10.

As a preferred embodiment, an end of the threaded connecting part 152 proximate to the first funnel part 151 extends along a radial direction to form a supporting part 154. The biological sample processing device 100 further includes a filter 40. The filter 40 is located in the lower connecting portion 15 and abuts against the supporting portion 154.

As a preferred embodiment, the lower end of the lower cover 30 is located in a same plane, and the plane is perpendicular to a central axis of the containing bottle 10.

Specifically, the lower end of the lower cover 30 is located in the same plane, and the plane is perpendicular to the central axis of the containing bottle 10, so that the biological sample processing device 100 can be stably rested on a horizontal table through the lower cover 30.

As a preferred embodiment, the upper cover assembly 20 further includes an upper seal 25. The upper sealing member 25 is disposed at an upper side of the through hole provided in the upper cover 21 and cooperates with the lower sealing member 22 to close a cavity enclosed by the upper cover 21 for containing the solution reacted with the biological sample.

Specifically, the upper seal 25 and the lower seal 22 completely seal the cavity enclosed by the upper cover 21 for containing the solution reacted with the biological sample, so that the solution reacted with the biological sample is completely isolated from the outside. Meanwhile, the upper seal 25 can also function to prevent the piston 23 from being pressed by mistake.

The biological sample processing device 100 is used in following steps as follows. The user unscrews the upper cover 21, collects the biological sample in the containing bottle 10, and screws the upper cover 21; tears the upper seal 25, pushes the piston 23 to cause the cross-shaped puncturing element 24 at the lower part of the piston 23 to pierce the lower seal 22, in which case the solution reacted with the biological sample enters the containing bottle 10 to be mixed with the biological sample inside therein, and then stand at room temperature for 20 to 30 min; place the biological sample processing device 100 in a centrifuge and centrifuge at 5000 g for 15 min at room temperature; and unscrew the lower cover 30 to squeeze the elastic bottle body 14, in this case the precipitates are filtered by the filter 40, and supernatant fluid flows out from the liquid outlet 12.

The basic principles, main features and advantages of the present disclosure are shown and described in the above. It should be understood by those skilled in the industry that the above embodiments do not limit the present disclosure in any form, and all technical solutions obtained by equivalent substitution or equivalent transformation fall within the protection scope of the present disclosure.

What is claimed is:

1. A biological sample processing device, comprising a containing bottle for containing a biological sample to be processed, wherein a receiving opening is provided at an upper end of the containing bottle and a liquid outlet is provided at a lower end of the containing bottle, the biological sample processing device further comprises an upper cover assembly and a lower cover, the upper cover assembly is connected to the upper end, where the receiving opening is provided, of the containing bottle, and the lower cover is connected to the lower end, where the liquid outlet is provided, of the containing bottle; wherein the upper cover assembly comprises an upper cover, a lower seal, a piston and a puncturing element, the upper cover is provided with a through hole, and the lower seal is disposed at a lower side of the through hole provided in the upper cover so that the upper cover forms a cavity for containing a solution reacted with the biological sample, the puncturing element is connected to the piston, the piston is closely matched with an inner wall of the through hole provided in the upper cover and sliding along the inner wall to drive the puncturing element to pierce the lower seal, and the upper cover is at least partially positioned in a cavity provided in the containing bottle.

2. The biological sample processing device according to claim 1, wherein
the biological sample processing device further comprises a filter, and the filter is placed in the cavity provided in the containing bottle to divide the cavity provided in the bottle into a first cavity and a second cavity.

3. The biological sample processing device according to claim 1, wherein
the containing bottle comprises an upper connecting part, an elastically deformable bottle body and a lower connecting part, the bottle body is connected with the upper connecting part and the lower connecting part, the upper connecting part is provided with the receiving opening, and the lower connecting part is provided with the liquid outlet.

4. The biological sample processing device according to claim 3, wherein
an external thread is provided at an outer side of the upper connecting part, an upper end of the upper cover is integrally provided with a sleeve portion with an internal thread defined on an inner wall of the sleeve portion, and the inner wall of the sleeve portion is provided with the internal thread matched with the external thread provided at the outer side of the upper connecting part.

5. The biological sample processing device according to claim 4, wherein
a gap is provided between the upper cover and the bottle body.

6. The biological sample processing device according to claim 3, wherein
the lower connecting part is funnel-shaped, the liquid outlet is located at a tip of the lower connecting part, and the lower cover is provided with a funnel-shaped inner cavity matched with the lower connecting part.

7. The biological sample processing device according to claim 6, wherein
the lower connecting part comprises a first funnel part, a cylindrical threaded connecting part with an external thread provided at an outer side of the threaded connecting part, and a second funnel part, the first funnel part is connected to a lower end of the bottle body, an end of the threaded connecting part is connected to the first funnel part and the other end of the threaded connecting part is connected to the second funnel part; the liquid outlet is located at a tip of the second funnel part; and an inner wall of the funnel-shaped inner cavity, matched with the lower connecting part, of the lower cover is provided with an internal thread matched with the external thread provided at the outer side of the threaded connecting part.

8. The biological sample processing device according to claim 7, wherein
an end of the threaded connecting part proximate to the first funnel part extends along a radial direction to form a supporting part; the biological sample processing device further comprises a filter, and the filter is positioned in the lower connecting part and abutting against the supporting part.

9. The biological sample processing device according to claim 1, wherein
a lower end of the lower cover is located in a same plane, and the plane is perpendicular to a central axis of the containing bottle.

10. The biological sample processing device according to claim 1, wherein
the upper cover assembly further comprises an upper sealing member, and the upper sealing member is disposed at an upper side of the through hole provided in the upper cover and the upper sealing member is cooperating with the lower sealing member to close the cavity enclosed by the upper cover for containing the solution reacted with the biological sample.
